(19) United States
(12) Patent Application Publication
(10) Pub. No.: US 2007/0085647 A1
(43) Pub. Date: Apr. 19, 2007

(54) INDUCTOR

(76) Inventor: MITSUGU KAWARAI, TOKYO (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/558,637

(22) Filed: Nov. 10, 2006

Related U.S. Application Data
(62) Division of application No. 11/388,804, filed on Mar. 23, 2006.

(30) Foreign Application Priority Data
Mar. 23, 2005 (JP) 2005-083529
Jul. 5, 2005 (JP) 2005-196252

(51) Int. Cl. H01F 27/02

(52) U.S. Cl. 336/83

(57) ABSTRACT

An inductor that can be mounted on a flexible substrate and which also can be used in large-current signal lines or power lines. The inductor has a film-type coil formed by providing, in order, a heat-resistant resin film, a flexible conductor coil and insulation layer for covering the conductor coil. A compound magnet that combines magnetic powder and resin is disposed on one or both sides of the film-type coil, with the heat-resistant resin film, the insulation layer and the compound magnetic body being at least flexible.

This application claims the benefit of Japanese Patent Applications No. 2005-083529 filed on Mar. 23, 2005 and No. 2005-196252 filed on Jul. 5, 2005, the entire contents of which are hereby incorporated by reference herein.

### BACKGROUND OF THE INVENTION

1. Field of the Invention

The present invention relates to an inductor, and more particularly, to an inductor used in a variety of electronic devices such as mobile telephones and mobile equipment, as well as in electronic instruments for automobiles.

2. Description of the Related Art

A conventional inductor uses baked ferrite or press-molded metal powder for the core. In addition, even in the type of inductor that uses a hoop or the like for the electrode, the core is very rigid, and thus the inductor hardly ever deforms. As a result, the inductor has poor resistance to bending, and moreover, stands up poorly to the impact of drop tests and the like. In addition, when the inductor is mounted on a flexible substrate, although the conventional rigid inductor can be mounted on the substrate if it is a small one, a large one quickly becomes unable to bend with the substrate, thus rendering installation on a flexible substrate is impossible.

As a solution to this problem there is known, for example, the inductor disclosed in Japanese Laid-Open Patent Application Publication No. 2000-91135 (“Pat. Pub. No. 2000-91135”).

At the inductor disclosed in Pat. Pub. No. 2000-91135, flexible insulating resin sheets are affixed to both sides of an inductor component composed of a meandering conductor formed as a single piece from a thin sheet of copper. The inductor component and the resin sheets are flexible, and therefore the inductor disclosed in Pat. Pub. No. 2000-91135 is flexible.

However, the inductor disclosed in Pat. Pub. No. 2000-91135 is composed of a thin copper sheet sandwiched between insulating resin sheets and does not include magnetic material. Therefore, such an inductor amounts to an air core spiral inductor. The inductance of such an inductor is small. As a result, although an air core spiral inductor can be used in a signal line for minute electric currents at high-frequency/low inductance, it is difficult to use such an inductor in large-current signal lines or power lines and the like, with their high-inductance/high superimposed characteristics.

### SUMMARY OF THE INVENTION

Accordingly, the present invention is conceived in light of above-described circumstances, and has an object to provide an inductor that is both capable of being mounted on a flexible substrate and used in large-current signal lines or power lines.

To achieve the above-described object, the present invention provides an inductor comprising a film-type coil formed from, in order, a heat-resistant resin film, a flexible conductor coil and an insulation layer for covering the conductor coil, with a compound magnet combining magnetic powder and resin formed on one or both sides of the film-type coil, and the heat-resistant resin film, the insulation layer and the compound magnet are at least flexible.

With such a structure, because the structural elements of the inductor, that is, the heat-resistant resin film, the insulation layer and the compound magnet are at least flexible, the inductor is flexible. Therefore, the inductor can accommodate bending of the substrate and thus can be mounted on flexible substrates as well. In addition, because the inductor is flexible, it is capable of withstanding the impact of drop tests and the like. Further, providing a compound magnet on the film-type coil increases the inductance of the inductor, enabling it to be used in power lines and the like through which large electric currents flow.

In addition, according to one aspect of the present invention, the conductor coil is formed by overlaying the heat-resistant resin film with an electrically conductive thin layer. In such a structure, since the conductor coil is formed as a thin layer, the conductor coil is flexible. As a result, the film-type coil can accommodate bending of the substrate on which it is mounted.

In addition, according to another aspect of the present invention, the conductor coil and the insulation layer are formed by pattern-printing an electrically conductive paste and a resin solution onto the heat-resistant resin film. In such a structure, because an electrically conductive paste and printing are used to form the conductor coil and the insulation layer, the conductor coil and the insulation layer can be formed on the heat-resistant resin film accurately and inexpensively.

In addition, according to another and further aspect of the present invention, the conductor coil is pattern-formed by etching, electroplating, electrocasting, printing or vapor-coating a metal onto the heat-resistant resin film. With such a structure, the thickness of the conductor coil can be changed easily, enabling the degree of flexibility of the inductor as a whole to be varied easily as a result. In addition, since a uniform layer thickness can be obtained for even complicated shapes, it is possible to increase the accuracy with which the conductor coil is formed.

In addition, according to yet another and further aspect of the present invention, a punch hole is formed on a portion of the heat-resistant resin film on which the conductor coil is not formed. In such a structure, the compound magnet goes into the punch hole, so that a gap is not formed with the magnetic flux generated by the conductor coil. As a result, the inductance of the inductor can be increased, enabling the inductor to be used in large-current power lines.

In addition, the present invention provides an inductor comprising a film-type coil formed from, in order, a heat-resistant resin film, a flexible conductor coil and an insulation layer for covering the conductor coil, with a magnet disposed on one or both sides of the film-type coil, and the heat-resistant resin film, the insulation layer and the magnet are at least flexible.

With such a structure, because the structural elements of the inductor, that is, the heat-resistant resin film, the insulation layer and the magnet are at least flexible, the inductor is flexible. Therefore, the inductor can accommodate bending of the substrate and thus can be mounted on flexible substrates as well. In addition, because the inductor is flexible, it is capable of withstanding the impact of drop tests and the like. Further, providing a magnet on the film-type coil makes it possible to maintain the flexibility of the inductor and to increase the inductance of the inductor, thus enabling the inductor to be used in power lines and the like through which large electric currents flow

In addition, according to one aspect of the present invention, both ends of the conductor coil are exposed at end surfaces of the heat-resistant resin film and connected to an external electrode, and an insulator is disposed between said external electrode and the magnet. With such a structure, a gap is formed with the magnet where the insulator is disposed, increasing the magnetic permeability of the magnet provided on the inductor. Therefore, magnetic saturation of the magnet can be prevented, enabling the superimposed DC characteristics of the inductor to be improved.

In addition, according to another aspect of the present invention, a plurality of conductor coils is provided. In such a structure, disposing multiple conductor coils in a single inductor enables the performance of the inductor to be improved and allows the inductor to be made more compact.

In addition, according to another and further aspect of the present invention, the magnet is a metal magnetic layer. With such a structure, the magnet can be formed as a thin layer, and therefore the magnet can be made flexible. As a result, the inductor can be made thin, and can accommodate bending of the substrate on which it is mounted.

In addition, according to yet another and further aspect of the present invention, metal magnetic layer is a foil manufactured by rolling or formed by quenching molten metal. In such a structure, the metal magnetic layer can be formed as a thin layer, enabling the inductor to be made thin as well.

In addition, according to yet another and further aspect of the present invention, the metal magnetic layer is formed by electrocasting, electroplating, or vapor-coating including physical vapor deposition (PVD). When so constructed, the metal magnetic layer can be formed as a thin layer, enabling the inductor to be made thin. Moreover, because the thickness of the metal magnetic layer can be easily changed, the degree of flexibility of the inductor as a whole also can be varied easily. In addition, since a uniform layer thickness can be obtained for even complicated shapes, it is possible to increase the accuracy with which the conductor coil is formed.

In addition, according to yet another and further aspect of the present invention, wherein the metal magnetic layer is heat treated. Such a structure enables the residual strain of the metal magnetic layer to be removed, eliminating the brittleness of the metal magnetic layer and thereby making it easy to maintain the flexibility of the metal magnetic layer.

In addition, according to yet another and further aspect of the present invention, the conductor coil is formed by overlaying the heat-resistant resin film with an electrically conductive thin layer. When so constructed, since the conductor coil is formed as a thin layer, the conductor coil is flexible, and as a result the film-type coil can accommodate bending of the substrate on which it is mounted.

In addition, according to yet another and further aspect of the present invention, the conductor coil and the insulation layer are formed by pattern-printing an electrically conductive paste and a resin solution onto the heat-resistant resin film. When thus constructed, since an electrically conductive paste and printing are used in the formation of the conductor coil and the insulation layer, the conductor coil and the insulation layer can be formed on the heat-resistant resin film accurately and inexpensively.

In addition, according to yet another and further aspect of the present invention, the conductor coil is pattern-formed by etching, electroplating, electrocasting, printing, PVD of or vapor-coating a metal onto the heat-resistant resin film. When so constructed, the thickness of the metal magnetic layer can be easily changed, and as a result, the degree of flexibility of the inductor as a whole also can be changed easily. Moreover, since a uniform layer thickness can be obtained for even complicated shapes, it is possible to increase the accuracy with which the conductor coil is formed.

According to the present invention, the inductor can be mounted on a flexible substrate and can also be used in large-current signal lines or power lines.

Other features, objects and advantages of the present invention will be apparent from the following description when taken in conjunction with the accompanying drawings, in which like reference characters designate the same or similar parts throughout the figures thereof.

### BRIEF DESCRIPTION OF THE DRAWINGS

FIG. 1 is a diagram showing a plan view of an inductor according to a first embodiment of the present invention when viewed from the perspective of a surface that is not mounted on a substrate;

FIG. 2 is a diagram showing a cross-sectional side view of the structure of the inductor shown in FIG. 1 when cut along a line A-A;

FIG. 3 is a diagram showing an enlarged view of a part of the inductor shown in FIG. 2 indicated by arrow B;

FIGS. 4A and 4B are diagrams showing the structure of a film-type coil, in which FIG. 4A shows a plan view when seen from above and FIG. 4B shows a plan view when seen from below;

FIG. 5 is a diagram showing a cross-sectional side view of the film-type coil shown in FIG. 4;

FIG. 6 is a diagram showing an enlarged view of a part of the film-type coil shown in FIG. 5 indicated by arrow C;

FIGS. 7A, 7B and 7C are diagrams showing the structure of the inductor shown in FIG. 1 when cut along the line A-A, in which FIG. 7A is a cross-sectional side view in a case in which the total thickness of the compound magnet is 100 μm, FIG. 7B is a cross-sectional side view in a case in which the total thickness of the compound magnet is 200 μm, and FIG. 7C is a cross-sectional side view in a case in which the total thickness of the compound magnet is 400 μm;

FIG. 8 is a cross-sectional side view of a state in which the center of the film-type coil shown in FIG. 5 has been punched out;

FIG. 9 is a diagram showing a plan view of the structure of a conductor coil when viewed from above the film-type coil shown in FIG. 8;

FIG. 10 is a diagram showing a cross-sectional side view of an inductor constructed using the film-type coil shown in FIG. 8;

FIG. 11 is a diagram showing a plan view of an inductor according to a second embodiment of the present invention when viewed from the perspective of a surface that is not mounted on a substrate;

FIG. 12 is a diagram showing a cross-sectional side view of the structure of the inductor shown in FIG. 11 when cut along a line D-D;

FIG. 13 is a diagram showing the structure of the inductor shown in FIG. 11 when cut along a line D-D, and a cross-sectional side view in a case in which the total thickness of the metal magnetic layer is 20 μm;

FIG. 14 is a diagram showing the structure of the inductor shown in FIG. 11 when cut along a line D-D, and a cross-sectional side view in a case in which the total thickness of the metal magnetic layer is 100 μm;

FIG. 15 is a diagram showing the structure of the inductor shown in FIG. 11 when cut along a line D-D, and a cross-sectional side view in a case in which the total thickness of the metal magnetic layer is 200 μm;

FIG. 16 is a diagram showing the structure of the inductor shown in FIG. 11 when cut along a line D-D, and a cross-sectional side view in a case in which the total thickness of the metal magnetic layer is 400 μm; and

FIG. 17 is a diagram showing the structure of the inductor shown in FIG. 11 when cut along a line D-D, and a cross-sectional side view in a case in which the total thickness of the metal magnetic layer is 1000 μm.

### DETAILED DESCRIPTION OF THE PREFERRED EMBODIMENTS

Preferred embodiments of the present invention will now be described, with reference to the accompanying drawings.

First Embodiment

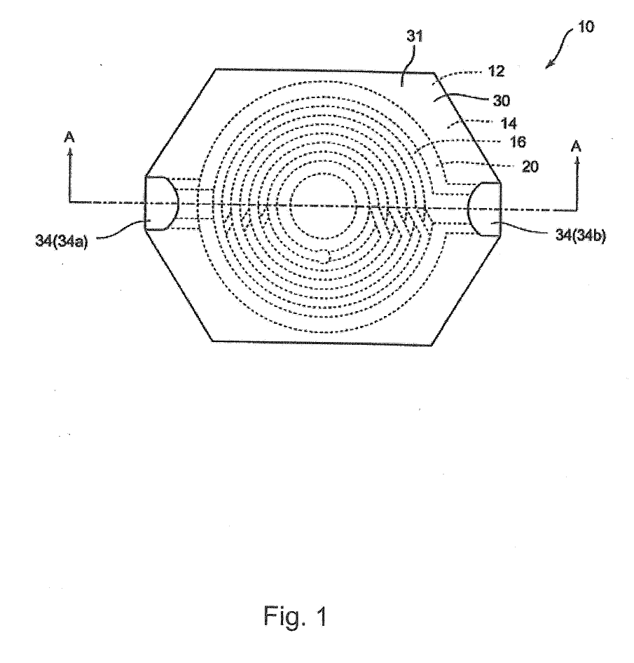

A description will now be given of an inductor 10 according to a first embodiment of the present invention, using FIGS. 1-10 and TABLE 1.

FIG. 1 is a diagram showing a plan view of an inductor 10 when viewed from the perspective of a surface that is not mounted on a substrate.

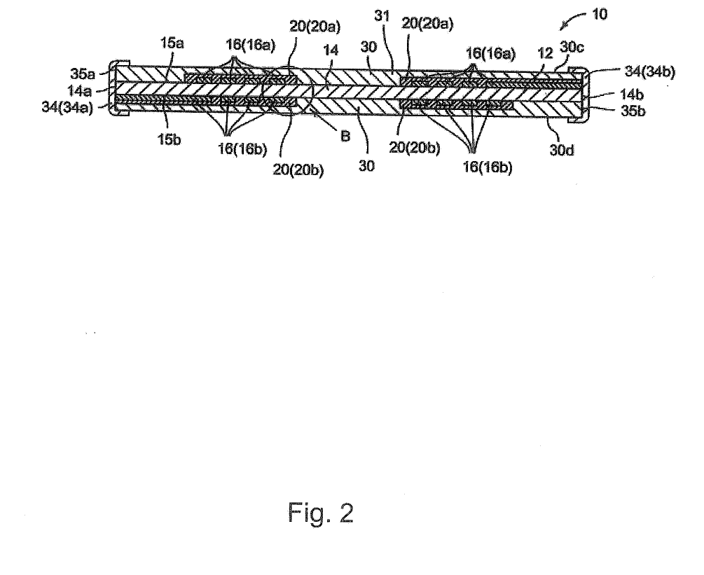

FIG. 2 is a diagram showing a cross-sectional side view of the structure of the inductor 10 shown in FIG. 1 when cut along a line A-A.

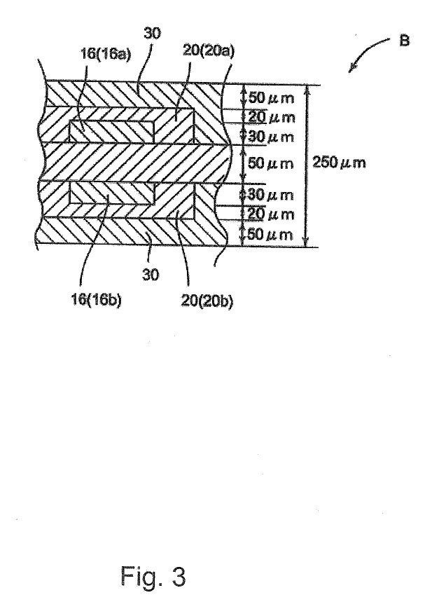

FIG. 3 is a diagram showing an enlarged view of a part of the inductor 10 shown in FIG. 2 indicated by arrow B.

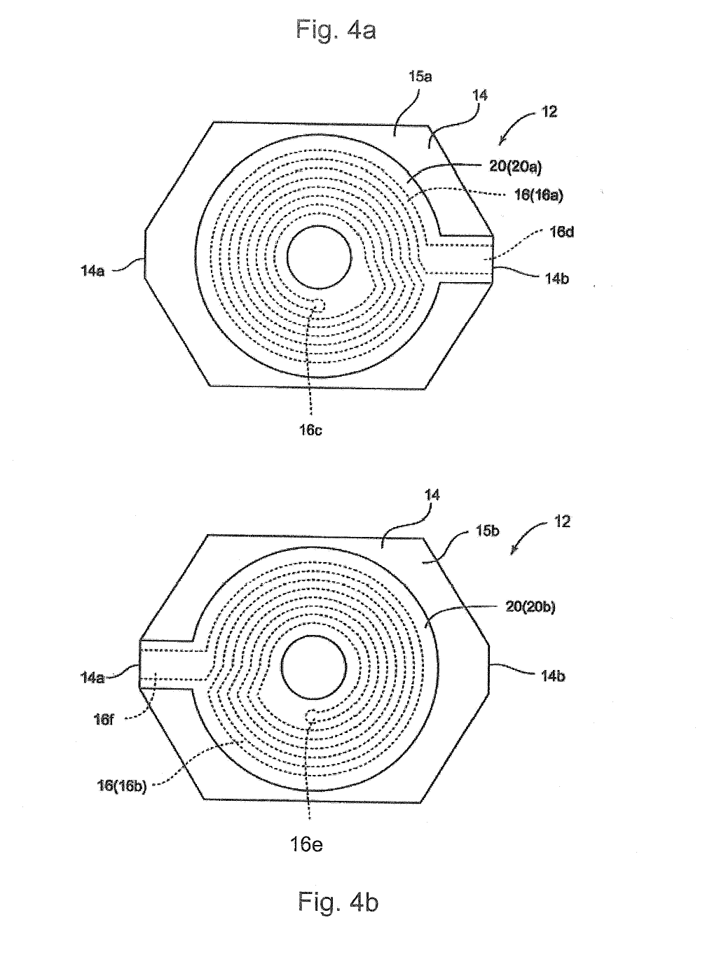

FIGS. 4A and 4B are diagrams showing the structure of a film-type coil 12, in which FIG. 4A shows a plan view when seen from above and FIG. 4B shows a plan view when seen from below.

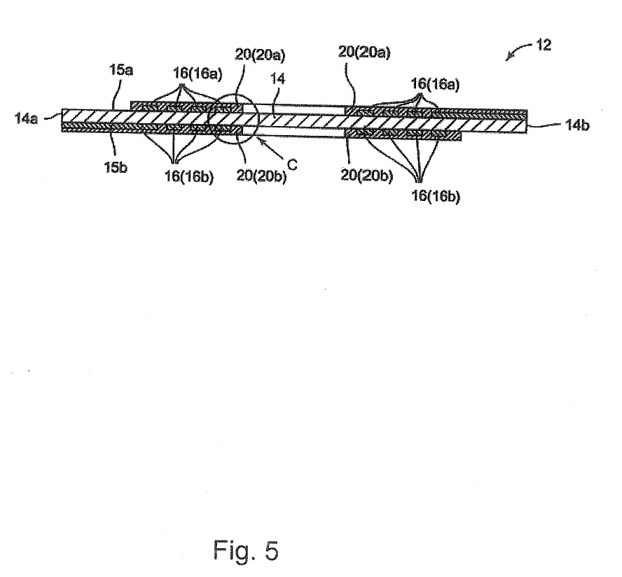

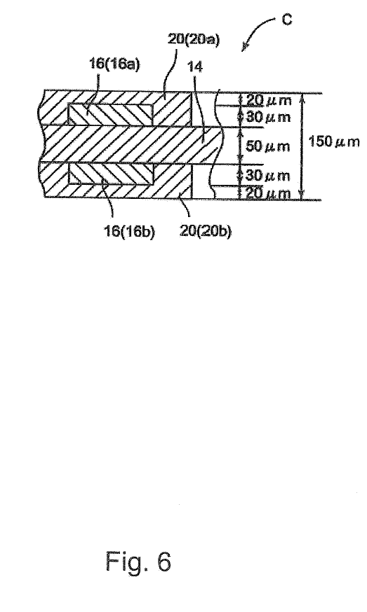

FIG. 5 is a diagram showing a cross-sectional side view of the film-type coil 12 shown in FIG. 4. FIG. 6 is a diagram showing an enlarged view of a part of the film-type coil 12 shown in FIG. 5 indicated by arrow C.

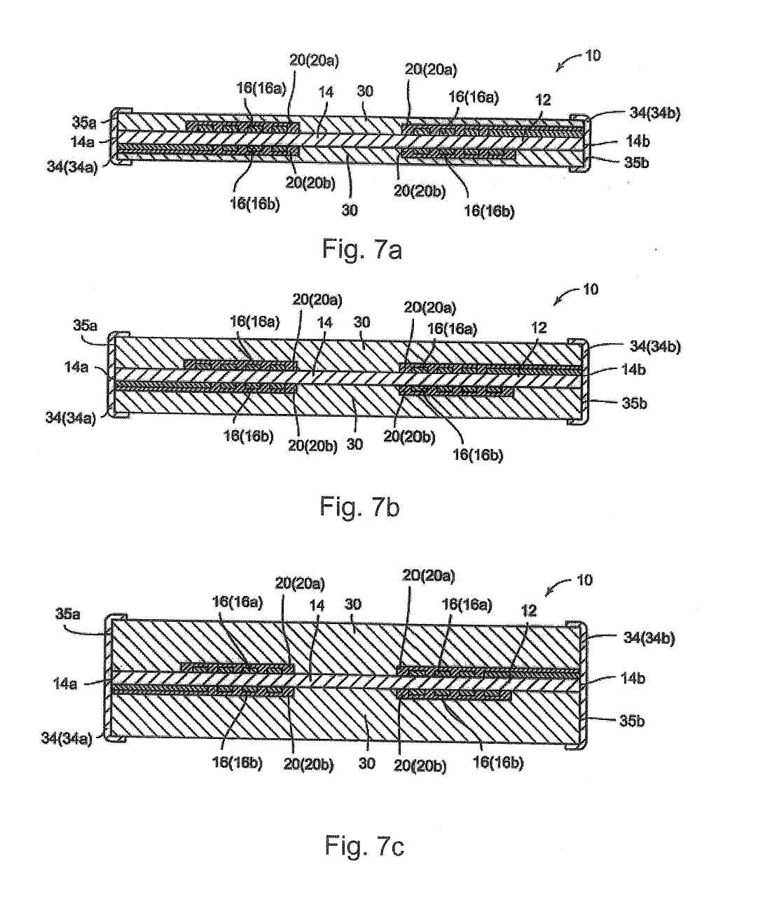

FIGS. 7A, 7B and 7C are diagrams showing the structure of the inductor 10 shown in FIG. 1 when cut along the line A-A, in which FIG. 7A is a cross-sectional side view in a case in which the total thickness of the compound magnet 30 is 100 μm, FIG. 7B is a cross-sectional side view in a case in which the total thickness of the compound magnet 30 is 200 μm, and FIG. 7C is a cross-sectional side view in a case in which the total thickness of the compound magnet 30 is 400 μm.

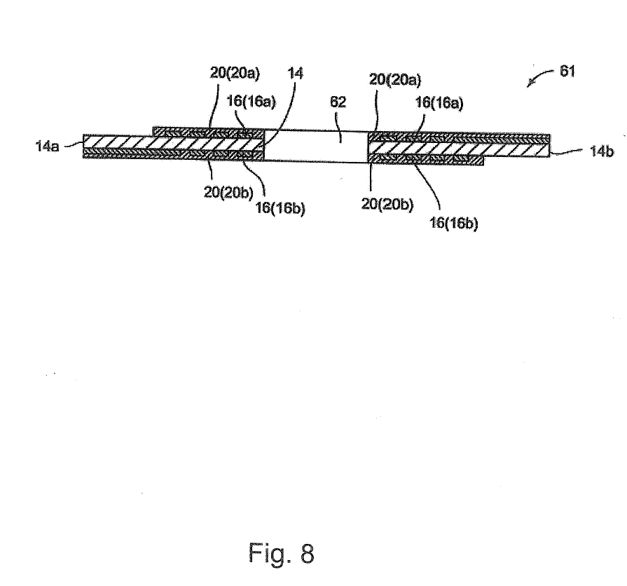

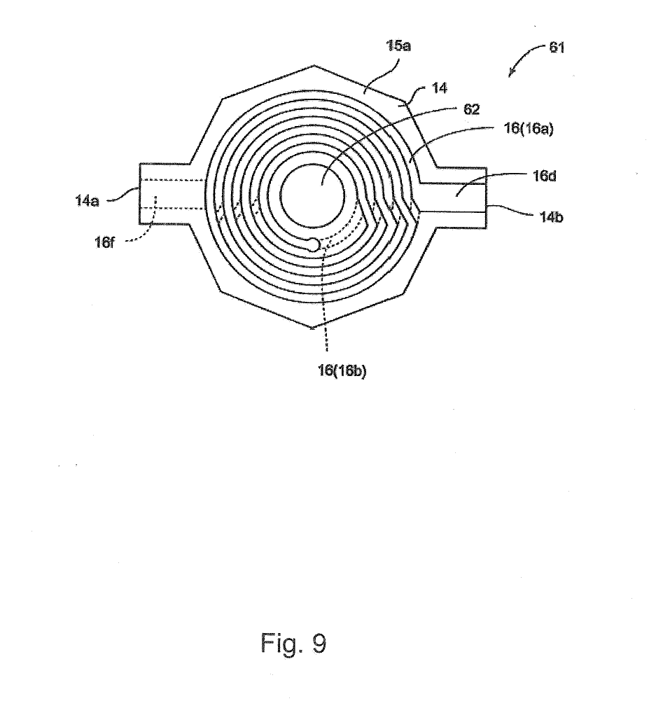

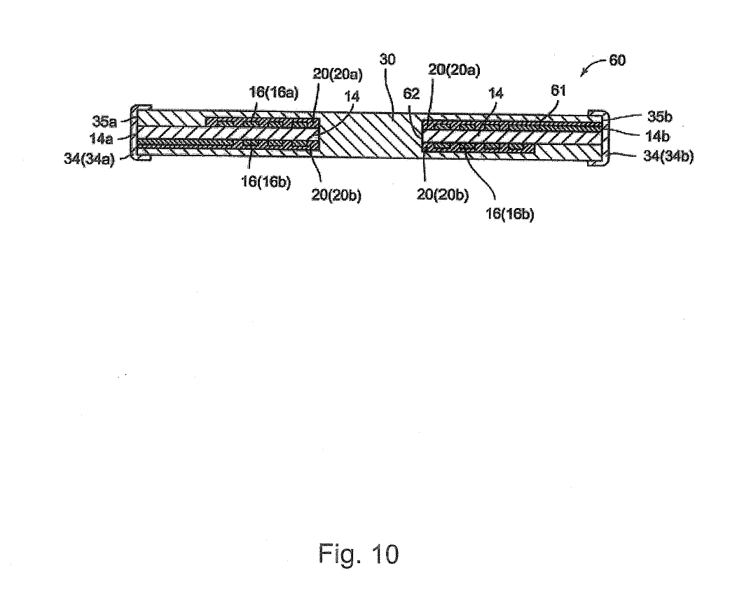

FIG. 8 is a cross-sectional side view of a state in which the center of a film-type coil 61 shown in FIG. 5 has been punched out. FIG. 9 is a diagram showing a plan view of the structure of a conductor coil 16 when viewed from above the film-type coil 61 shown in FIG. 8. FIG. 10 is a diagram showing a cross-sectional side view of an inductor 60 constructed using the film-type coil 61 shown in FIG. 8.

TABLE 1 shows the relation between the thicknesses of the compound magnet 30 used in the inductor 10 and the inductance of the inductor 10.

It should be noted that, in the following description, the proximal end means the left side and the distal end means the right side. In addition, in FIGS. 2, 3 and 5-9, the top indicates the upper side and the bottom indicates the lower side.

As shown in FIGS. 1 and 2, the inductor 10 comprises mainly an inductor component 31 and an external electrode 34 that electrically connects the inductor 10 and a substrate on which the inductor 10 is mounted. In addition, the inductor component 31 is composed primarily of a flexible film-type coil 12 and a compound magnet 30 disposed so as to sandwich such film-type coil 12. It should be noted that what is defined as flexible in the present embodiment is that which, when bent to a degree equal to one third the length of the inductor 10, such inductor 10 maintains the equivalent of its initial performance without breakdown.

Further, as shown in FIGS. 4A, 4B and 5, the film-type coil 12 is composed of a heat-resistant resin film 14, spiral-shaped conductor coils 16a, 16b (hereinafter referred to as conductor coil 16 when the conductor coils 16a, 16b are referred to collectively) formed on a top surface 15a and a bottom surface 15b of the heat-resistant resin film 14, and insulation layers 20a, 20b (hereinafter referred to as insulation layer 20 when the insulation layers 20a, 20b are referred to collectively) disposed so as to cover the conductor coil 16.

As shown in FIGS. 4A and 4B, the conductor coil 16 is formed in the shape of a spiral on the top surface 15a and the bottom surface 15b of the flexible heat-resistant resin film 14. The shape of the heat-resistant resin film 14 is an octagon in vertical section with respect to a diagonal line that connects a set of peaks disposed opposite each other within a hexagon. The cut-off portions form end surfaces 14a, 14b. It should be noted that either polyimide film or PET (polyethylene terephthalate) is employed as the heat-resistant resin film 14. As shown in FIG. 4A, on the top surface 15a of the heat-resistant resin film 14 the conductor coil 16a is formed in the shape of a counter-clockwise spiral, with the proximal end 16c of the conductor coil 16a penetrating the heat-resistant resin film 14 below the center of the spiral toward the bottom surface 15b. The distal end of the conductor coil 16a extends from the outer edge of the spiral toward the end surface 14b, and contacts the end surface 14b. The conductor coil 16a is formed by sticking the rolled copper foil on top of the heat-resistant resin film 14 and patterning the coil with a resist exposure, after which the rolled copper foil is etched. If necessary, after the rolled copper foil is stuck onto the top of the heat-resistant resin film 14, the rolled copper foil may be copper-plated onto the heat-resistant resin film 14. In the present embodiment, with respect to the etching, chemical etching is employed to remove the thin film and resist chemically. The method of forming the conductor coil 16a is not limited to that of etching a pattern formed by resist exposure, and alternatively the pattern of the copper foil may be formed by irradiation of an ion-beam or other laser as well as by plasma etching using a mask. In addition, the method of forming the conductor coil 16a is not limited to etching, and alternatively the pattern may be formed by pattern printing of an electrically conductive paste, electroplating, electrocasting, metal foil printing or vapor deposition such as PVD (Physical Vapor Deposition). The conductor coil 16a is formed as a thin layer by such methods, and therefore such conductor coil 16a is flexible.

As shown in FIG. 4B, on the bottom surface 15b of the conductor coil 16a the conductor coil 16b is formed as a circular clockwise spiral. A distal end 16e of the conductor coil 16b is connected to the proximal end 16c of the conductor coil 16a that penetrates the heat-resistant resin film 14 from the top surface 15a below the center of the spiral. A proximal end 16f of the conductor coil 16b extends from the outer edge of the spiral toward the end surface 14a, and contacts the end surface 14a. The method of forming the conductor coil 16b is the same as that of forming the conductor coil 16a.

Insulation layers 20a, 20b are formed on the top surface 15a and the bottom surface 15b of the heat-resistant resin film 14 so as to cover the conductor coils 16a, 16b. The insulation layer 20 is provided in order to prevent the surface of the conductor coil 16 from becoming electrically conductive. The insulation layer 20a, as shown in FIG. 4A, is formed so as to extend toward the end surface 14b on the distal end side from the outer edge of a cylindrical shape formed so as to cover the conductor coil 16a. In addition, as shown in FIG. 5, the insulation layer 20a is inserted between adjacent spiral-shaped conductor coils 16a, 16a, as a result making it possible to prevent adjacent conductor coils 16a, 16a from becoming conductive. The insulation layer 20a is formed by pouring an insulation layer-forming resin solution over the conductor coil 16a from above and printing the pattern. As a result, the insulation layer 20a forms a thin film and is flexible. The insulation layer 20b as well, as shown in FIG. 4B, like the insulation layer 20a, is formed on the bottom surface 15b. The shape of the insulation layer 20b is such as to extend toward the end surface 14 a of the proximal end from the outer edge of the cylindrical shape formed so as to cover the conductor coil 16b. In addition, the insulation layer 20b, like the insulation layer 20a, is inserted between adjacent conductor coils 16b, 16b, thus preventing such adjacent conductor coils 16b, 16b from becoming conductive.

Thus, as described above, on the film-type coil 12, the conductor coils 16a, 16b, except for the end surface portions 14a, 14b, are respectively completely covered by the insulation layers 20a, 20b, and thus the conductor coils 16a, 16b are not conductive to the outside except for end surfaces 14a, 14b. In the present embodiment, as shown in FIG. 6, the total thickness of the film-type coil 12 is 150 μm, which is the sum of the 50 μm, 30 μm and 20 μm thicknesses of the heat-resistant resin film 14, the conductor coil 16 and the insulation layer 20, respectively. In this case, the thicknesses of the heat-resistant resin film 14 can also have a range of 20-100 μm. the thickness of the conductor coil 16 can also have a range of 10-50 μm, and the thickness of the insulation layer 20 can also have a range of 5-40 μm.

As shown in FIG. 2, a compound magnet 30 is disposed on both sides of the film-type coil 12, in such as way as to be tightly attached to both upper and lower surfaces of the film-type coil 12. The compound magnet 30 is flexible, and is formed by impregnating resin material with magnetic powder. Metal magnetic powder having iron as its main component and of no particular particle shape, or flexible ferrite powder, for example, is used as the magnetic powder. A flexible elastomer or plastomer, for example, is used as the resin.

In the inductor component 31, in which the film-type coil 12 is sandwiched by the compound magnet 30, external electrodes 34a, 34b (hereinafter referred to as external electrode 34 when the external electrodes 34a, 34b are referred to collectively), are formed on a proximal end surface 35a that corresponds to the proximal end side and a distal end surface 35b that corresponds to a distal end side. As shown in FIG. 2, the external electrodes 34a, 34b are thin films shaped like an inverted “C” in cross-section, and formed so as to extend from the proximal end surface 35a and the distal end surface 35b to an upper end surface 30c and a lower end surface 30d of the compound magnet 30. As a result, the external electrodes 34a, 34b are in contact with the proximal end surface 35a and the distal end surface 35b of the inductor component 31. Therefore, the external electrodes 34a, 34b also contact the end surfaces 14a, 14b of the film-type coil 12. In addition, the proximal end 16f of the conductor coil 16b and the distal end 16d of the conductor coil 16a are exposed at the end surfaces 14a, 14b, and therefore the external electrodes 34a, 34b securely contact the proximal end 16f of the conductor coil 16b and the distal end 16d of the conductor coil 16a. As a result, the conductor coil 16 is in electrically conductive contact with the substrate on which it is mounted through the external electrode 34. Therefore, electric current flows through the external electrode 34 to the conductor coil 16. An electroless plating film, a metal foil or a vapor-deposited film laid down by PVD or the like is employed as the external electrode 34.

Thus, as described above, the inductor 10 is created by forming external electrodes 34a, 34b on the proximal end surface 35a and the distal end surface 35b of the inductor component 31 that sandwiches the film-type coil 12 with the compound magnetic bodies 30. In addition, in the present embodiment, as shown in FIG. 3, the thickness of the inductor 10 totals 250 μm, in which the 150 μm thickness of the film-type coil 12 described above is sandwiched between the compound magnetic bodies 30 each with a thickness of 50 μm. Moreover, assuming that it is possible to maintain the flexibility of the inductor 10, the total thickness of both compound magnetic bodies 30 may be 200 μm or 400 μm as shown in FIGS. 7B and 7C. Further, as shown in FIGS. 8 and 9, a punch hole 62 may be formed in the center of the film-type coil 12 to create a film-type coil 61. Where the film-type coil 61 is used to form an inductor 60, then as shown in FIG. 10 compound magnet 30 is disposed not only on both top and bottom sides of the film-type coil 61 but also on the interior of the punch hole 62.

TABLE 1 shows the relation between the thickness of the compound magnet 30 and the inductance of the inductors 10, 60.

TABLE 1

| Thickness of the | Punch | |
|---|---|---|
| flexible compound | hole | |
| magnet | present? | Inductance |
| 50 μm | No | 0.6 μH |
| 100 μm | No | 1.2 μH |
| 200 μm | No | 1.6 μH |
| 300 μm | No | 2.1 μH |
| 50 μm | Yes | 1.5 μH |

As shown in TABLE 1, the inductance of the inductor 10 increases substantially proportionally to the thickness of the compound magnet 30. Accordingly, by changing the thickness of the compound magnet 30, it is possible to change the inductance of the inductor 10. Moreover, from TABLE 1 it is clear that, in the case of the film-type coil 61, in which the film-type coil 12 is provided with a punch hole 62, the inductance is more than twice the inductance of the film-type coil 12 when not provided with the punch hole 62. This is because, as shown in FIG. 10, in an inductor 60, the compound magnet 30 extends into the interior of the punch hole 62, thus eliminating any gap with the magnetic flux generated in the inductor 60. Therefore, by providing the punch hole 62 on the inductor 10 it is possible to increase the inductance.

Next, a description will be given of a method of manufacturing the inductor 10.

First, the conductor coil 16a, which spirals inward in the counter-clockwise direction from the end surface 14b, is formed on the top surface 15a of the heat-resistant resin film 14, which has been processed into a predetermined form. The conductor coil 16a is formed by sticking rolled copper foil onto the top surface 15a of the heat-resistant resin film 14 and performing patterning by resist exposure of the rolled copper foil, after which the rolled copper foil is then etched. Then, the proximal end 16c of the conductor coil 16a is threaded through the heat-resistant resin film 14 from the top surface 15a to the bottom surface 15b. The conductor coil 16b, threaded through to the bottom surface 15b, is then formed into a spiral that spirals outward in the clockwise direction from the distal end 16e thereof, until it reaches the end surface 14a. The conductor coil 16b is also formed by the same etching process as the conductor coil 16a.

Then, a resin solution for forming the insulation layer is poured over the conductor coil 16a from above and pattern printed to form the insulation layer 20a. The insulation layer 20a is formed so as to extend from the cylindrically shaped portion where the conductor coil 16a is formed toward the end surface 14b. The heat-resistant resin film 14 on which the insulation layer 20a is formed is then turned over and, as with conductor coil 16a, a resin solution for forming the insulation layer is poured over the conductor coil 16b from above and pattern printed to form the insulation layer 20b. By the foregoing process steps is the film-type coil 12 formed.

Then, the compound magnet 30 is disposed on both sides of the film-type coil 12 so as to sandwich the film-type coil 12. The compound magnet 30 is tightly attached to both upper and lower surfaces of the film-type coil 12. The inductor component 31 is formed by the foregoing process steps is. Next, the external electrodes 34a, 34b are formed on the proximal end surface 35a and the distal end surface 35b of the inductor component 31 by electroless plating or by PVD vapor coating or the like. The external electrodes 34a, 34b are formed so as to extend from the proximal end surface 35a and the distal end surface 35b of the inductor component 31 to the upper end surface 30c and the lower end surface 30d of the compound magnet 30 (see FIG. 2). The inductor 10 is manufactured by carrying out the foregoing process steps.

In the inductor 10 constituted in the manner described above, the heat-resistant resin film 14, the conductor coil 16, the insulation layer 20 and the compound magnet 30 that are the constituent elements of the inductor 10 are all flexible, and therefore the inductor 10 as a whole is flexible. Therefore, the inductor 10 can accommodate bending of the substrate on which it is mounted, and for that reason can withstand the impact of drop tests and the like. Further, by providing flexible compound magnetic bodies 30 on both sides of the film-type coil 12, the flexibility of the inductor 10 can be maintained and its inductance can be increased. As a result, the inductor 10 can also be used in low-frequency areas such as power lines through which large currents flow.

In addition, in the inductor 10 described above, the conductor coil 16 is formed by patterning by resist-exposure of the rolled copper foil and then etching the rolled copper foil. Since the conductor coil 16 is formed using etching, the conductor coil 16 can be patterned and formed on the heat-resistant resin film 14 accurately and inexpensively.

In addition, in the inductor 10, the conductor coil 16 is patterned and formed by etching, electroplating, electrocasting, printing or vapor-coating a metal onto the heat-resistant resin film 14. Since the conductor coil 16 is formed using such methods, the thickness of the conductor coil 16 can be easily varied. Accordingly, the degree of flexibility of the inductor as a whole can be easily changed. Moreover, because a uniform film thickness can be obtained for even complex shapes, the conductor coil 16 formation accuracy can be increased.

In addition, in the inductor 10, an electroless plating film, metal foil or vapor-deposited film deposited by PVD or the like is used for the external electrode 34. Since the thin film is formed by electroplating, printing or vapor deposition, the external electrode 34 can be formed as a thin layer of uniform thickness. Moreover, the thickness of the external electrode 34 film can be easily varied as well.

In addition, in the inductor 10 the compound magnet 30 is provided on both sides of the film-type coil 12. As a result, compared in a case in which the compound magnet 30 is not provided, the inductance of the inductor 10 can be greatly increased. Further, by adjusting the thickness of the compound magnet 30, it is possible to adjust the inductance of the inductor 10. Therefore, the inductor 10 can also be used in large-current power lines.

In addition, the punch hole 62 is formed in the inductor 60 described above, with the compound magnet 30 entering the interior of the punch hole 62. Therefore, no gap is formed with the magnetic flux generated by the conductor coil 16. As a result, the inductance of the inductor 60 can be further increased, making the inductor 60 suitable for use in large-current power lines.

Second Embodiment

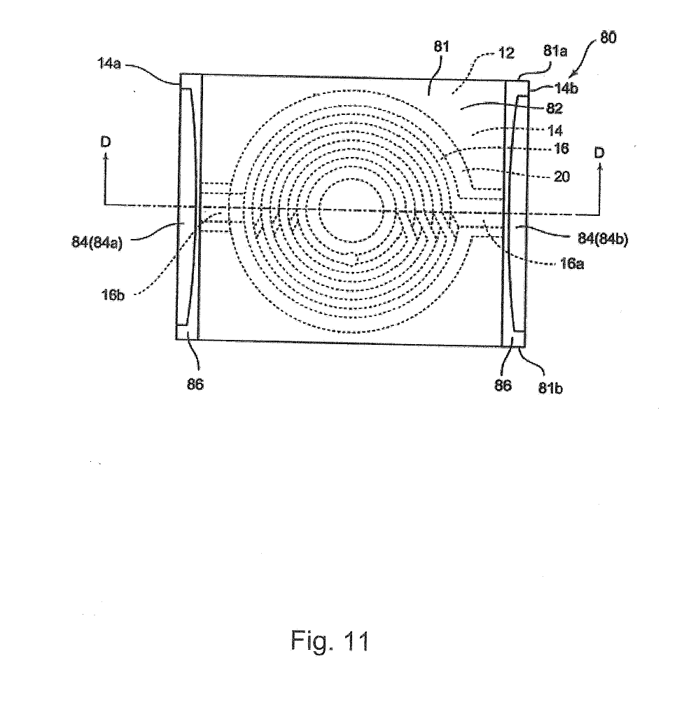

A description will now be given of an inductor 80 according to a second embodiment of the present invention, with reference to FIGS. 11-17 and TABLE 2.

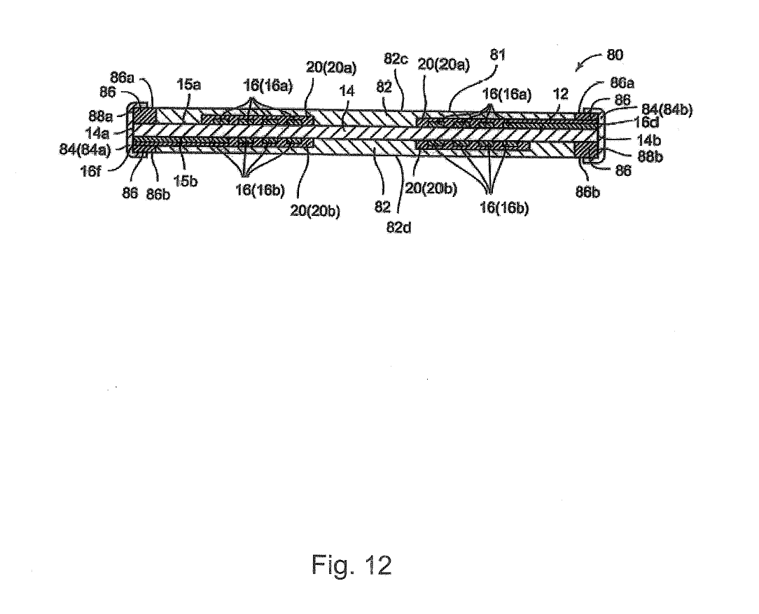

FIG. 11 is a diagram showing a plan view of an inductor 80 when viewed from the perspective of a surface that is not mounted on a substrate. FIG. 12 is a diagram showing a cross-sectional side view of the structure of the inductor 80 shown in FIG. 11 when cut along a line D-D.

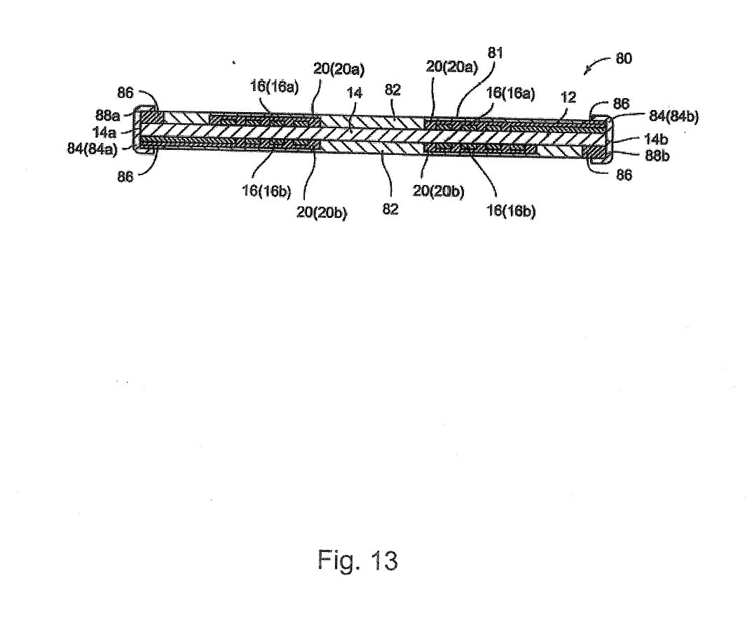

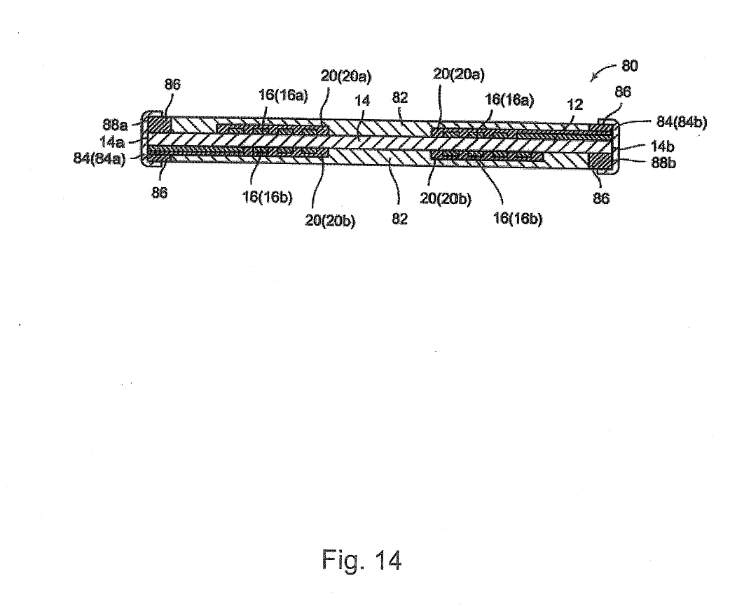

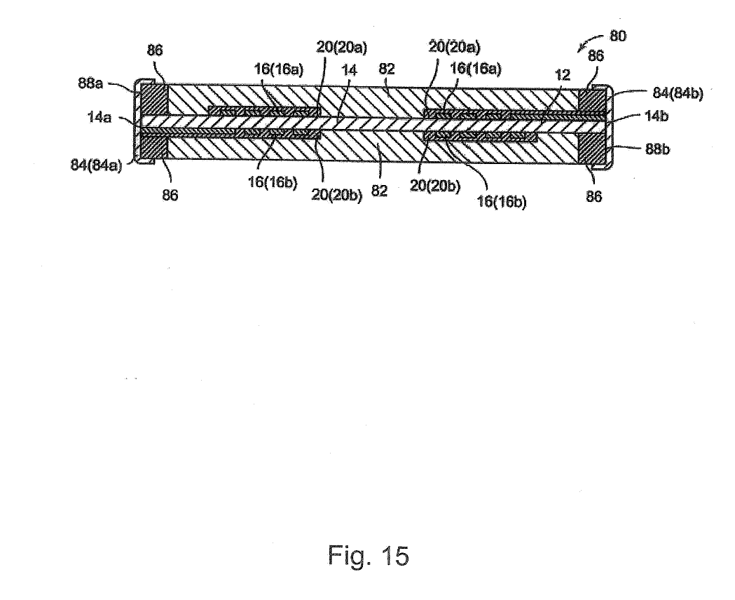

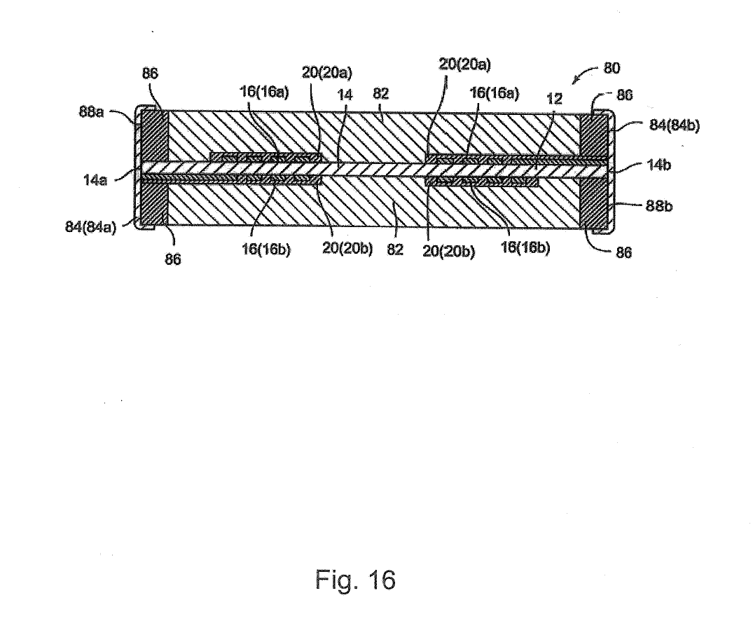

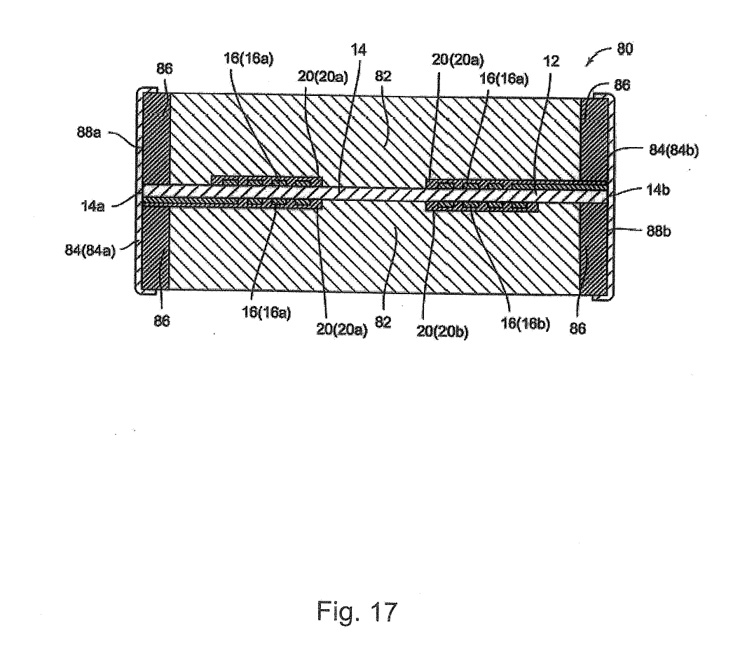

FIG. 13 is a diagram showing the structure of the inductor 80 shown in FIG. 11 when cut along a line D-D, and a cross-sectional side view in a case in which the total thickness of the metal magnetic layer(a kind of magnet) 82 is 20 μm. FIG. 14 is a diagram showing the structure of the inductor 80 shown in FIG. 11 when cut along a line D-D, and a cross-sectional side view in a case in which the total thickness of the metal magnetic layer 82 is 100 μm. FIG. 15 is a diagram showing the structure of the inductor 80 shown in FIG. 11 when cut along a line D-D, and a cross-sectional side view in a case in which the total thickness of the metal magnetic layer 82 is 200 μm. FIG. 16 is a diagram showing the structure of the inductor 80 shown in FIG. 11 when cut along a line D-D, and a cross-sectional side view in a case in which the total thickness of the metal magnetic layer 82 is 400 μm. FIG. 17 is a diagram showing the structure of the inductor 80 shown in FIG. 11 when cut along a line D-D, and a cross-sectional side view in a case in which the total thickness of the metal magnetic layer 82 is 1000 μm. TABLE 2 shows the relation between the thickness of the metal magnetic layer 82 and the inductance of the inductor 80.

It should be noted that, in the following description, the proximal end means the left side and the distal end means the right side. Moreover, in FIGS. 12-17, the top indicates the upper side and the bottom indicates the lower side. In addition, members and parts that are the same as those in the first embodiment are assigned the same reference numerals and descriptions thereof omitted or simplified. It should be noted that, in the second embodiment, the structure is largely the same as that of the first embodiment, and thus the description concentrates on that which is different from the first embodiment.

As shown in FIGS. 11 and 12, the inductor 80 comprises mainly an inductor component 81 and an external electrode 84 that electrically connects the inductor 80 and a substrate on which the inductor 80 is mounted. In addition, the inductor component 81 is composed primarily of a flexible film-type coil 12, the metal magnetic layer 82 disposed so as to sandwich the film-type coil 12, and an insulationcover layer 86 disposed at a proximal end and adistal end of the metal magnetic layer 82.

As in the first embodiment, in the second embodiment the film-type coil 12 comprises a heat-resistant resin film 14, a conductor coil 16 formed on the top surface 15a and the bottom surface 15b of the heat-resistant resin film 14 in the shape of a circular spiral, and an insulation layer 20 disposed so as to cover the conductor coil 16.

In the present embodiment, the shape of the heat-resistant resin film 14 is a rectangle, with end surfaces of the proximal end side and the distal end side forming end surfaces 14a, 14b. In addition, the proximal end and the distal end of conductor coils 16a, 16b contact the end surfaces 14a, 14b. In the present embodiment as well, the conductor coil 16 is formed by sticking rolled copper foil onto the top surface 15a and the bottom surface 15b of the heat-resistant resin film 14 and patterning the coil with a resist exposure, after which the rolled copper foil is etched. As a result, the conductor coil 16 is flexible.

As with the first embodiment, the insulation layer 20 is provided in order to prevent the surface of the conductor coil 16 from becoming electrically conductive with some external part. In addition, the insulation layer 20 is cylindrically shaped so as to cover the conductor coil 16, and contacts the end surfaces 14a, 14b. The insulation layer 20 is formed by pouring a resin solution for forming the insulation layer over the conductor coil 16 from above and printing the pattern. As a result, the insulation layer 20a forms a thin layer and is flexible. The thickness of the film-type coil 12 in the present embodiment is the same as in the first embodiment.

As shown in FIG. 12, the metal magnetic layers 82 are disposed on both sides of the film-type coil 12. The metal magnetic layer 82, which is disposed so as to adhere tightly to both the top and bottom surfaces of the film-type coil 12, is flexible, and is either foil formed by rolling a magnet or foil formed by quenching molten magnetic material. Iron, permalloy or ferrite, for example, may be used for the magnet. For the rolling method, either powder rolling, involving rolling the powder while electrothermally heating it to form a thin film, or hot rolling and the like, which involves rolling the powder at high temperature, may be used. In addition, the metal magnetic layers 82 may be thin films of metal magnetic material formed by electrocasting, electroplating or vapor deposition by PVD and the like. Moreover, by heat-treating the metal magnetic layer 82, the residual strain present in the metal magnetic layer 82 is removed. Such heat treatment is conducted in a vacuum or in a non-oxidation space containing argon or nitrogen. The lower limit of the temperature of the heat treatment is 400□ regardless of the material, and in particular 600□ or more being optimal. The upper limit of the temperature is optimally a temperature that is equivalent to 70 percent of the temperature needed to melt the materials (that is, the melting point of each material). The thickness of the metal magnetic layer 82 formed in the foregoing manner is from several μm to 100 μm.

As shown in FIGS. 11 and 12, the insulation cover layer 86 formed from insulating material is provided at the proximal end and the distal end both metal magnetic layers 82, 82 that sandwich the film-type coil 12. Further, external electrodes 84a, 84b (hereinafter referred to as external electrode 84 when the external electrodes 84a, 84b are referred to collectively) are formed on end surfaces 88a, 88b of the proximal end side and the distal end side of the inductor 81 in which the film-type coil 12 is sandwiched by the metal magnetic layer 82. As shown in FIG. 12, the external electrodes 84a, 84b are thin films shaped like an inverted “C” in cross-section, and formed so as to extend from the proximal end surface 88a and the distal end surface 88b of the inductor component 81 to an upper end surface 86a and a lower end surface 86b of the insulation cover layer 86. In addition, the external electrode 84 is formed so as to extend from the vicinity of a top end portion 81a of the inductor component 81 shown in FIG. 11 to the vicinity of a bottom end portion 81b of the inductor component 81. The external electrodes 84a, 84b contact the proximal end surface 88a and the distal end surface 88b of the inductor component 81. Therefore, the external electrodes 84a, 84b also contact the end surfaces 14a, 14b of the film-type coil 12. In addition, the proximal end 16f of the conductor coil 16 and the distal end 16d of the conductor coil 16 are exposed at the end surfaces 14a, 14b, and therefore the external electrodes 84a, 84b securely contact the proximal end 16f of the conductor coil 16b and the distal end 16d of the conductor coil 16a. Therefore, the conductor coil 16 is in electrically conductive contact with the substrate on which it is mounted through the external electrode 84. As a result, electric current flows through the external electrode 84 to the conductor coil 16. An electroless plating film, a metal foil or a vapor-deposited film laid down by PVD or the like is employed as the external electrode 34.

In the present embodiment as well, as show in FIG. 3, the thickness of the inductor 80 the thickness of the inductor 10 totals 250 μm, in which the 150 μm-thick film-type coil 12 described above is sandwiched between the two metal magnetic layers 82 each with a thickness of 50 μm. Moreover, assuming that it is possible to maintain the flexibility of the inductor 80, the total thickness of the metal magnetic layers 82 may be 20 μm, 100 μm, 200 μm, 400 μm or 1000 μm as shown in FIGS. 13-17.

TABLE 2 shows the relation between the thickness of the metal magnetic layer 82 and the inductance of the inductor 80.

TABLE 2

| Thickness of the | |
|---|---|
| metal magnetic | |
| layer | Inductance |
| 10 μm | 0.4 μH |
| 25 μm | 1.0 μH |
| 50 μm | 1.8 μH |
| 100 μm | 3.6 μH |
| 200 μm | 4.8 μH |
| 300 μm | 6.5 μH |
| 500 μm | 10 μH |

As shown in TABLE 2, the inductance of the inductor 80 increases substantially proportionally to the thickness of the metal magnetic layer 82. Accordingly, by changing the thickness of the metal magnetic layer 82, it is possible to change the inductance of the inductor 80. Moreover, from a comparison of TABLE 1 and TABLE 2 it is clear that, in the present embodiment, the inductance is approximately three times that of the first embodiment. This is because the magnetic permeability of the metal magnetic layer 82 is greater than the magnetic permeability of the compound magnet 30: Whereas the magnetic permeability of the compound magnet 30 employed in the inductor 10 according to the first embodiment is in the range of 10-100 [H/m], the magnetic permeability of the metal magnetic layer 82 used in the inductor 80 according to the second embodiment is in the range of 3000-20000 [H/m]. In addition, in the inductor 80, the insulation cover layer 86 forms a gap with the magnetic flux generated in the inductor 80 and thus higher superimposed DC characteristics can be obtained in the inductor 80. The method of manufacturing the inductor 80 is the same as that of the method of manufacturing the inductor 10 except for the provision of the insulation cover layer 86, and therefore a description thereof is omitted.

In the inductor 80 constituted in the manner described above, heat-resistant resin film 14, the conductor coil 16, the insulation layer 20 and the metal magnetic layer 82 that are the constituent elements of the inductor 80 are all flexible, and therefore the inductor 80 as a whole is flexible. Therefore, the inductor 80 can accommodate bending of the substrate on which it is mounted, and for that reason can withstand the impact of drop tests and the like. Further, by providing flexible metal magnetic layer 82 on both sides of the film-type coil 12, the flexibility of the inductor 80 can be maintained and its inductance can be increased. As a result, the inductor 80 can also be used in low-frequency areas such as power lines through which large currents flow.

In addition, in the inductor 80 described above, the magnet is a thin metal magnetic layer 82, therefore making the magnet flexible. As a result, the inductor 80 is flexible, and at the same time, the inductor 80 can be made more compact. Moreover, since the magnetic permeability of the metal magnetic layer 82 is a high 3000-20000 [H/m], the inductance of the inductor 80 increases.

In addition, in the inductor 80, the insulation cover layer 86 is disposed at the proximal end and the distal end of the insulation cover layer 86, and thus a gap is formed with the metal magnetic layer 82 where the insulation cover layer 86 is provided and the magnetic permeability of the metal magnetic layer 82 provided in the inductor 80 increases. Therefore, magnetic saturation of the metal magnetic layer 82 can be prevented, enabling the superimposed DC characteristics of the inductor to be improved.

In addition, in the inductor 80, the metal magnetic layer 82 is either foil manufactured by rolling or foil formed by quenching molten material. As a result, the metal magnetic layer 82 can be formed as a thin layer, enabling the inductor 80 to be made thin as well.

In addition, in the inductor 80, the metal magnetic layer is formed by electrocasting, electroplating, or vapor-coating including physical vapor deposition (PVD). When so constructed, the metal magnetic layer can be formed as a thin layer, enabling the inductor to be made thin. Moreover, because the thickness of the metal magnetic layer can be easily changed, the degree of flexibility of the inductor as a whole also can be varied easily. In addition, since a uniform layer thickness can be obtained for even complicated shapes, it is possible to increase the accuracy with which the metal magnetic layer 82 is formed.

In addition, in the inductor 80, the metal magnetic layer 82 is heat treated. As a result, the residual strain present in the metal magnetic layer 82 can be removed, eliminating the brittleness of the metal magnetic layer 82 and thereby making it easy to maintain the flexibility of the metal magnetic layer 82.

It should be noted that although in the embodiments described above PVD is used to form the external electrodes 34, 84, different means may be used to form the external electrodes 34, 84, such as chemical vapor deposition (CVD). In addition, maskless portions may be formed using a mask and a thin layer formed on such portions.

In addition, although in the embodiments described above the inductors 10, 80 are given a two-layer structure in which the conductor coil 16 is formed across two layers, the present invention is not limited to such a construction and the inductors 10, 80 may have a structure comprising three or more layers, or, alternatively, only one layer. Where the inductors 10, 80 have a multi-layer construction, disposing a plurality of conductor coils 16 in a single inductor allows the performance of the inductors 10, 80 to be improved as well as permits the inductors 10, 80 to be made more compact.

In addition, in the embodiments described above, the compound magnet 30 and the metal magnetic layer 82 are provided on both sides of the film-type coil 12. However, alternatively, the compound magnet 30 and the metal magnetic layer 82 may be provided on only one side of the film-type coil 12.

In addition, although in the embodiments described above the conductor coil 16 is formed in the shape f a circular spiral, the conductor coil 16 is not limited to such a shape, and alternatively, may be formed in the shape of a square spiral or made to meander.

In addition, although in second embodiment described above the lower limit of the heat treatment temperature for the metal magnetic layer 82 is set at or above 400□ and the upper limit is set at a temperature equivalent to 70 percent of the temperature needed to melt the material (the melting point of the material), the present invention is not limited thereto. Alternatively, the lower limit temperature may be at or below 400□ and the upper limit temperature may be more than 70 percent of the melting point of the material.

In addition, although in the second embodiment described above the magnetic permeability of the metal magnetic layer 82 is in the range of 3000-20000 [H/m], the present invention is not limited thereto. Accordingly, the magnetic permeability of the metal magnetic layer 82 may be 3000 [H/m] or less, or 20000 [H/m] or more.

In addition, although in the second embodiment described above the insulation cover layer 86 is provided on the proximal end and the distal end of the inductor 80, the insulation cover layer 86 need not be provided at all.

Although in the second embodiment described above electrocasting, electroplating or PVD are employed in the formation of the metal magnetic layer 82, the present invention is not limited thereto. Accordingly, other means, such as chemical vapor deposition (CVD), may be used.

Although in the second embodiment described above no punch hole is cut out of the center of the inductor 80, such a punch hole may be provided.

The inductor of the present invention can be used in a variety of devices, including mobile telephones, mobile equipment, electronic instruments for automobiles and the like.

As many apparently widely different embodiments of the present invention can be made without departing from the spirit and scope thereof, it is to be understood that the invention is not limited to the specific preferred embodiments described above thereof except as defined in the claims.

1-5. (canceled)

6. An inductor comprising:
a film-type coil formed from, in order, a heat-resistant resin film, a flexible conductor coil and an insulation layer for covering the conductor coil,
a magnet disposed on one or both sides of the film-type coil, the heat-resistant resin film, the insulation layer and the magnet being at least flexible.

7. The inductor according to claim 6, wherein both ends of the conductor coil are exposed at end surfaces of the heat-resistant resin film and connected to an external electrode, and an insulator is disposed between said external electrode and the magnet.

8. The inductor according to claim 6, wherein a plurality of conductor coils are provided.

9. The inductor according to claim 6, wherein the magnet is a metal magnetic layer.

10. The inductor according to claim 9, wherein the metal magnetic layer is a foil manufactured by rolling or formed by quenching molten metal.

11. The inductor according to claim 9, wherein the metal magnetic layer is formed by electrocasting, electroplating, or vapor-coating including physical vapor deposition (PVD).

12. The inductor according to claim 9, wherein the metal magnetic layer is heat treated.

13. The inductor according to claim 6, wherein the conductor coil is formed by overlaying the heat-resistant resin film with an electrically conductive thin layer.

14. The inductor according to claim 6, wherein the conductor coil and the insulation layer are formed by pattern-printing an electrically conductive paste and a resin solution onto the heat-resistant resin film.

15. The inductor according to claim 6, wherein the conductor coil is pattern-formed by etching, electroplating, electrocasting, printing, PVD of or vapor-coating a metal onto the heat-resistant resin film.
